(19) United States
(12) Patent Application Publication
(10) Pub. No.: US 2014/0372885 A1
(43) Pub. Date: Dec. 18, 2014

(54) PROVIDING HELP SUGGESTIONS BASED ON ONLINE ACTIVITY OF A CONTACT

(71) Applicant: Ranjith JAYARAM, San Jose, CA (US)

(72) Inventor: Ranjith JAYARAM, San Jose, CA (US)

(73) Assignee: Google Inc., Mountain View, CA (US)

(21) Appl. No.: 13/538,769

(22) Filed: Jun. 29, 2012

(51) Int. Cl. G06F 3/048

(52) U.S. Cl. 715/705

(57) ABSTRACT

A computer-implemented method for providing help suggestions at a social networking site is provided. The method includes receiving from a user an electronic help request identifying one or more contacts, classifying the received electronic help request into one or more help categories, generating an electronic help invitation at least in part based on the received electronic help request and the one or more help categories, sending an electronic help invitation to the one or more contacts identified in the electronic help request. The method concludes with receiving an acceptance of the electronic help invitation from at least one contact of the one or more contacts identified in the electronic help request; and providing, based on the at least one contact's of one or more contacts online activity, an electronic help suggestion to the one or more contact who received the electronic help invitation.

### TECHNICAL FIELD

The subject disclosure relates generally to electronic communications, and in particular, to providing electronic help suggestions to a user in response to an electronic help request from another user at a social networking site.

### BACKGROUND

People often ask their friends and acquaintances for their help; people solicit opinions, recommendations, or assistance with a particular task, issue or project. This is typically done in person, on the phone, by email, or by private or public messages within a social networking site. However, people often feel that it is inconsiderate or impolite to repeatedly seek help from others as they go about accomplishing a particular task or resolving an issue. Typically, people will have a couple of conversations with their friends about the project or exchange a few emails, and then the friend will usually assume the person has received enough information or is satisfied when the person does not continue to solicit the friend's help. However, the person may simply be uncomfortable about continuing to prod their friend for help. There is currently no convenient, non-intrusive way to enable friends to continue to be involved in their friends' projects beyond the initial interaction.

### SUMMARY

The disclosed technology teaches a process for providing an electronic help suggestion to a contact designated by a user at a social networking site. According to one aspect, a user desiring his contacts' input on a topic sends an electronic help request to a group of identified contacts. From the electronic help request, help categories are identified, relating to topics on which the user is asking his contacts for help. An electronic help invitation is sent to the contacts identified in the electronic help request, asking their permission to be provided with electronic help suggestions relevant to the user's electronic help request while the contact is engaged in his usual online activities. The contacts willing to participate accept the electronic help invitation, and the process concludes with electronic help suggestions being provided to those contacts based on the contacts' online activity and optionally, upon other factors. The additional factors may be whether or not an electronic help suggestion quota has been reached for an electronic help request, for a given contact, for a time-frame, or another similar parameter. Other additional factors may be whether or not a given contact's online activity is relevant to the electronic help request, the value of an electronic help suggestion to the user from a given contact, or a likelihood of electronic help suggestion approval by a given contact.

The disclosure of the present technology thus teaches a method for providing an electronic help suggestion. According to an aspect of the technology, the method includes the steps of receiving, using one or more computing devices, from a user an electronic help request identifying one or more contacts, classifying, using the one or more computing devices the received electronic help request into one or more help categories, generating, using the one or more computing devices, an electronic help invitation at least in part based on the received electronic help request and the one or more help categories, and sending the electronic help invitation, using the one or more computing devices, to the one or more contacts identified in the electronic help request. The method proceeds to receiving, using the one or more computing devices, an acceptance of the electronic help invitation from at least one contact of the one or more contacts identified in the electronic help request and providing an electronic help suggestion, using the one or more computing devices, to the at least one contact of one or more contact who accepted the electronic help invitation, based on the at least one contact's of the one or more contacts online activity.

According to another aspect, the disclosed technology provides a non-transient machine-readable medium comprising instructions stored therein, which when executed by a machine, cause the machine to perform operations including receiving from a user an electronic help request identifying one or more contacts, classifying the received electronic help request into one or more help categories and sending an electronic help invitation to the one or more contacts identified in the electronic help request. The operations also include receiving an acceptance of the electronic help invitation from at least one contact of the one or more contacts identified in the electronic help request, determining whether the at least one contact of the one or more contacts is engaged in online activity relevant to the electronic help request, wherein determining whether the at least one contact of the one or more contacts is engaged in online activity relevant to the electronic help request includes comparing the one or more classified help categories to the at least one contact of the one or more contacts' online activity, determining an electronic help suggestion type to provide to the at least one contact of the one or more contacts based on a type of the at least one contact's of one or more contacts online activity and providing an electronic help suggestion to the at least one contact of one or more contacts who accepted the electronic help invitation based on the at least one contact's of the one or more contacts online activity, according to the determined electronic help suggestion type.

According to a further aspect of the technology, a system is disclosed including one or more processors and a machine-readable medium comprising instructions stored therein, which when executed by the processors, cause the processors to perform operations including receiving from a user an electronic help request identifying one or more contacts, classifying the received electronic help request into one or more help categories and sending an electronic help invitation to the one or more contacts identified in the electronic help request, to provide help to the user on the one or more help categories classified in the electronic help request. The operations further include determining that at least one contact's of the one or more contacts online activity is relevant to the electronic help invitation and providing an electronic help suggestion based on the at least one contact's of one or more contacts online activity that is relevant to the electronic help invitation, to the at least one contact of the one or more contacts who received the electronic help invitation.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Features of the subject technology are set forth in the appended claims. However, for purpose of explanation, several aspects of the disclosed subject matter are set forth in the following figures.

FIG. 1 illustrates an example network environment which provides for providing an electronic help suggestion in a social networking site.

FIG. 2 is a flowchart illustrating an example process for providing an electronic help suggestion in a social networking site.

FIG. 3A is a diagram of an example user interface for providing an electronic help suggestion.

FIG. 3B is a diagram of an example user interface for providing an electronic help suggestion.

FIG. 4 conceptually illustrates an example of an electronic system with which some examples of the subject technology may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

### I. Overview

The disclosure of the present technology provides a process by which one or more of a user's contacts will receive meaningful suggestions related to a topic on which the one or more contacts have agreed to help that user. These suggestions will be made as the one or more contacts goes about their daily online activities. According to one aspect of the subject technology, an electronic help request identifying one or more contacts is made by a user and received at a social networking site. The electronic help request is categorized according to its subject matter and an invitation to help the user is sent to the identified one or more contacts. An acceptance may then be received from one or more of the contacts indicating that the respective contact is willing to receive suggestions on how he may help the user based on the respective contacts' online activities.

Upon receiving an acceptance from a contact, electronic help suggestions are provided to the contact based on the contact's online activity. That is, when the contact's online activity involves interacting with content that may be relevant to the electronic help request, an electronic help suggestion may be made to the contact to, for example, share that content with the user who asked for his help. When the contact views web pages related to the electronic help request, an electronic help suggestion may be made to share those web pages with the user. Likewise, when the contact executes searches relevant to the electronic help request, an electronic help suggestion may be made to share the results of those searches. When no explicit acceptance is received from a contact, the contact may still be provided with at least one electronic help suggestion when he is engaged in online activity that is relevant to the electronic help request. If the contact approves the electronic help suggestion, an acceptance of the electronic help invitation may be inferred.

Various other online activities, such as viewing email, checking in at establishments, or viewing photos may be practical for providing electronic help suggestions to a contact. A contact may specify which online activities are appropriate for being considered for such electronic help suggestions at the time the contact accepts the electronic help request or at any other time while the help request is active. Help requests may automatically expire after a certain time-frame defined by a user, contact or system. A user or a contact may also delete a help request at any time, even before the help request expires. The type of electronic help suggestion that is provided to the contact will depend largely on the type of activity giving rise to the suggestion. The types of electronic help suggestions may be sharing content or a photo, forwarding an email, starting a hangout, including the user in a conversation, or other similar actions.

The phrase “social networking site” as used herein encompasses its plain and ordinary meaning, including, but not limited to, an online service, platform or site that focuses on building and reflecting of social associations among users. These associations may be stored within a social graph at the social networking service. Such user associations may be defined on a user-to-user basis, or as a group of users associated through membership within a group. As used herein, “contacts” refers to other users at one or more social networking sites. As one example, a contact may have a user account at the social networking site.

### II. Example Client-Server Network Environments for Providing Electronic Help Suggestions

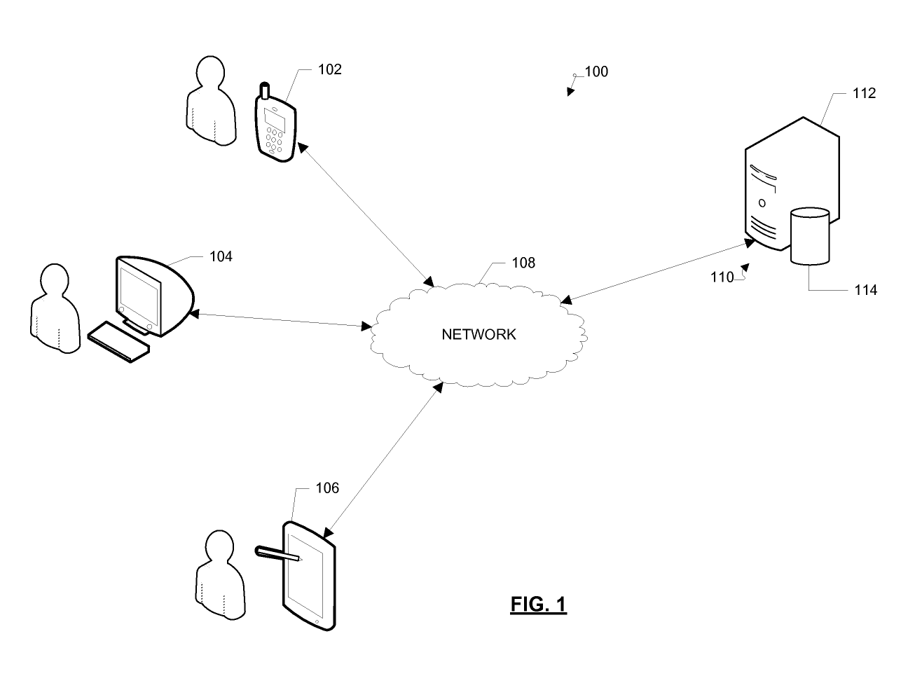

FIG. 1 illustrates an example network environment in which electronic help suggestions are provided to one or more users, according to one aspect of the subject technology. A network environment 100 includes a number of electronic devices 102-106 communicably connected to a server 110 by a network 108. Server 110 includes a processing device 112 and a data store 114. Processing device 112 executes computer instructions stored in data store 114, for example, to host a social networking site, including content upload functions, photo management, message boards, live chats, forum discussions and the like. Processing device 112 or other devices like it may also execute the processes discussed herein. A social networking site hosted by server 110 may include a photo management application that allows users of the social networking site to upload, modify or manage photos. Data store 114 may further include a database that stores various information pertaining to content uploaded to the social networking site hosted by server 110.

The social networking site hosted on server 110 may enable users (e.g., users of electronic devices 102-106) to create a profile and associate themselves with other users at the social networking site. A user of any of electronic devices 102-106 may interact with a social networking site hosted by server 110 through a client application installed at any of electronic devices 102-106. Alternatively, the user may interact with the social networking site through a web-based browser application at any of electronic devices 102-106.

Users interacting with electronic devices 102-106 can participate at a social networking site by posting messages such as text communications (e.g., comments, replies, announcements, status updates), digital photos, videos, or other electronic content. In some example embodiments, information can be posted on a user's behalf by systems and/or services external to server 110. For example, the user may share a photo through a photo sharing website, and with proper permissions, that website may include the photos in a social networking site stream, on the user's behalf. In another example, a software application executing on a mobile device (e.g., electronic device 102), with proper permissions, may use global positioning system (GPS) capabilities to determine the user's location and automatically update the social networking site with the user's location (e.g., “At Home”, “At Work”, “In Los Angeles, Calif.”).

Electronic devices 102-106 can be computing devices such as laptop or desktop computers, smartphones, PDAs, portable media players, tablet computers, televisions with one or more processors embedded therein and/or attached thereto, and/or other appropriate computing devices that can be used for social networking (e.g., for allowing user to assess items in a social networking site). In the example of FIG. 1, electronic device 102 is depicted as a smartphone, electronic device 104 is depicted as a desktop computer, and electronic device 106 is depicted as a PDA.

In some aspects, server 110 can be a single computing device such as a computer server. In other embodiments, server 110 can represent more than one computing device working together to perform the actions of a server computer (e.g., cloud computing). Communication between any of electronic devices 102-106 and server 110 may be facilitated through a network (e.g., network 108). Network 108 can be a public communication network (e.g., the Internet, cellular data network, dialup modems over a telephone network) or a private communications network (e.g., private LAN, leased lines). Communications between any of electronic devices 102-106 and server 110 may be facilitated through a communication protocol such as Hypertext Transfer Protocol (HTTP). Other communication protocols may also be facilitated for some or all communication between any of electronic devices 102-106 and server 110, including for example, Extensible Messaging and Presence Protocol (XMPP) communication.

### III. Example Processes for Providing an Electronic Help Suggestion

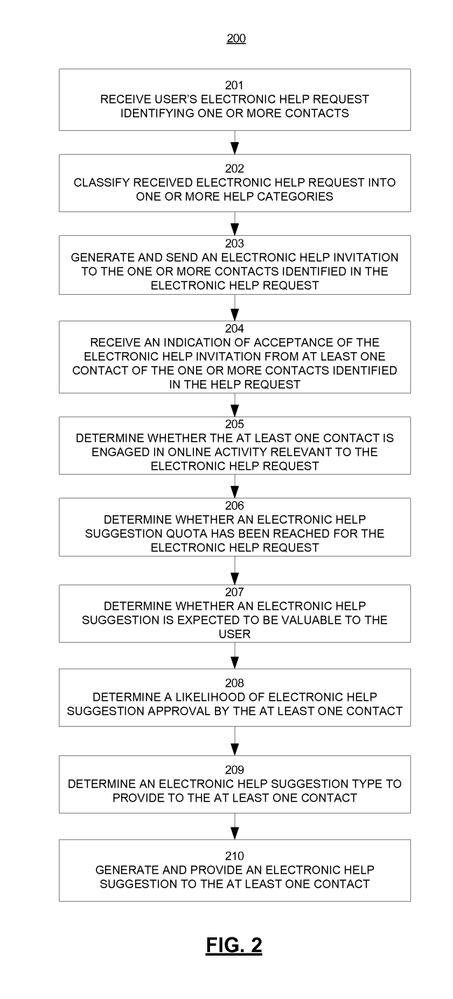

FIG. 2 is a flowchart illustrating an example process for providing an electronic help suggestion in a social networking site. Although the disclosed technology is discussed in the context of a social networking site, it is understood, that the disclosure is not limited to a social networking site and any other applicable context capable of carrying out the processes disclosed herein, is within the scope of the disclosed technology. At block 201, an electronic help request is received from a social networking site user, identifying one or more of the user's contacts at the social networking site. Persons whom a user wishes to include who are not already the user's contacts at a particular social networking site may receive an invitation to become a contact or to join the site, if not already a member, when selected by the user according to the methods disclosed herein. For example, users may contact such persons by selecting their email address, at which the selected person may receive the invitation. The help request also identifies one or more topics, hereinafter referred to as help topics, on which a user wishes to solicit his contacts' help.

Functionality enabling a user to send such a help request may be provided through an application residing on the social networking site hosted by server 110 or elsewhere on the network, or by an external application, device or tool. The help request may be transmitted as an internal communication at the social networking site, such as a private message, a public post, or another type of a communication. Alternatively, the help request may be transmitted by email, SMS or another electronic communication.

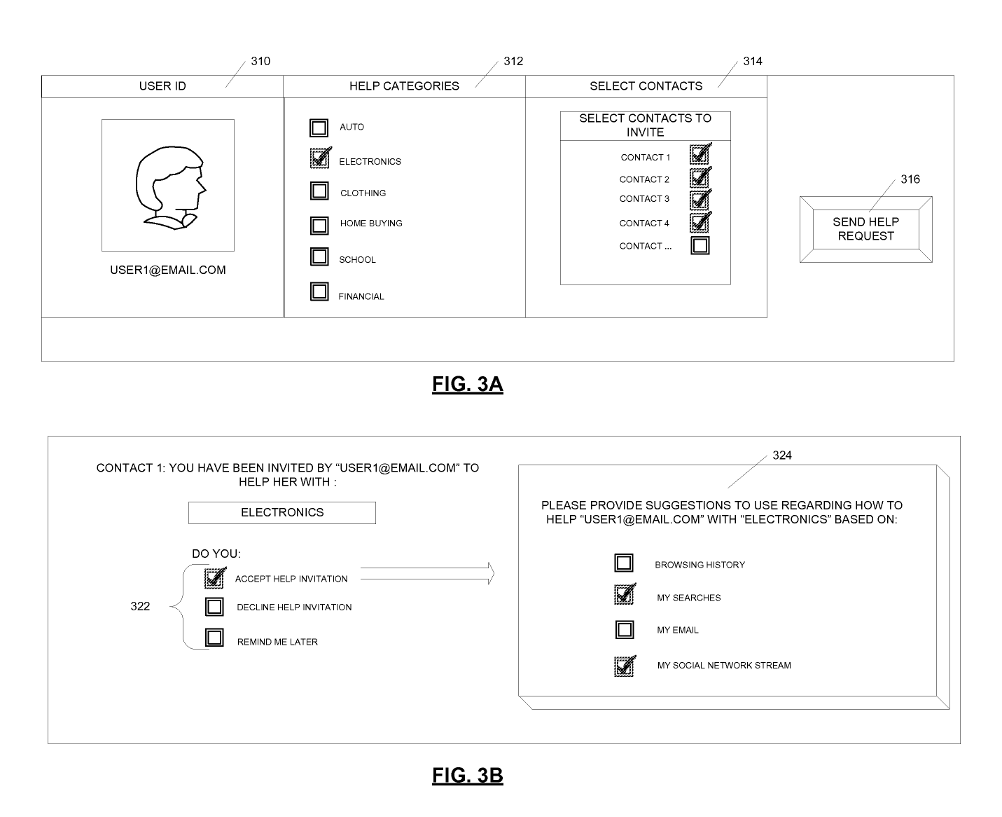

At block 202, the electronic help request is classified into one or more help categories. The help categories may be selected by the user from a list of pre-defined help categories, as described with reference to FIG. 3A, or the help categories may be classified from free-form content entered by the user when submitting the electronic help request. The free-form content entered by the user may include text, images, links, audio or video files, or other similar content, which may be classified into help categories. Various known language and image processing techniques may be employed to classify user-entered content into one or more help categories. A user may also be provided with an option to approve the classified help categories, once the user-entered, free-form content has been analyzed for help categories.

Upon classifying the electronic help request into one or more help categories, an electronic help invitation including the classified help categories is generated at least in part based on the received electronic help request and the one or more help categories, and sent to the one or more contacts identified in the help request, at block 203. The one or more contacts may respond to the electronic help invitation by accepting, declining or snoozing the invitation, as shown with reference to FIG. 3B. According to an aspect of the disclosed technology, an indication of acceptance of the electronic help invitation may be received at block 204 from at least one contact from the one or more contacts. Acceptance of the electronic help invitation is an authorization to monitor some or all of the one or more contacts' online activity to identify useful information for the electronic help request. As part of accepting the electronic help invitation or, in addition thereto, the at least one contact of the one or more contacts may specify the types of online activity the system is authorized to monitor. For example, the at least one contact who accepted the invitation may specify that internet browsing, social network streams and internet searches are authorized to be monitored, but email accounts are not.

Functionality enabling the sending and receiving of such invitations and acceptances, respectively, may be provided through an application residing on the social networking site hosted by server 110 or elsewhere, or by an external application, device or tool. An electronic help invitation or an acceptance thereof may, in turn, be sent to the one or more contacts or a user, respectively, as an internal communication at the social networking site, such as a private message, a public post, or another type of a communication. Alternatively, an electronic help invitation may be sent to the one or more contacts or an acceptance may be received by a user by email, SMS or another electronic communication.

At block 205, a determination is made regarding whether or not the at least one contact is engaged in online activity that is relevant to the electronic help request. Making such a determination may include monitoring the online activity authorized by the at least one contact to be monitored when he or she accepted the invitation, and comparing the one or more classified help categories to the at least one contact's online activity. If it is determined that the online activity is relevant, an electronic help suggestion may be generated and provided to the at least one contact. The help suggestion may be provided to the at least one contact right away, or held back, pending further processing or analysis. According to an example process, at block 206, an additional determination may be made regarding whether a help suggestion quota has or has not been reached for the electronic help request. The quota may pertain to a total number of suggestions received for: a certain time period; a certain topic; a certain contact; or another similar parameter. If the quota has not been reached, the help suggestion may be provided to the one or more contacts, or held back further.

Another determination regarding whether the electronic help suggestion is valuable for the user from whom the help request identifying the one or more contacts is received, may be made at block 207. A quality check analysis may be performed to determine whether or not a pending suggestion is valuable to a user. This determination may involve weighing other pending suggestions to identify the best suggestion or ranking a pending suggestion's relevance. For example, a key word analysis may be performed to identify the more valuable suggestion from a pool of pending suggestions. A filter may be implemented requiring a threshold number of key word or other matches before a suggestion is determined to be valuable. Likewise, a help history between a user and the one or more contacts may be analyzed for such a determination. A filter may be used to prioritize suggestions originating from certain contacts based on the user's review of that contact's previous suggestions or another similar factor. Such help history may be locally or remotely stored in a database.

Contacts may also be ranked according to those who are more likely to help versus those who are least likely to help, or whose help is most valued, based on ratio of click-throughs for help suggestions originating from a particular contact, or another similar mechanism. For example, users may be asked to vote after viewing or clicking through a suggestion, whether the suggestion was helpful. Suggestions that gather the highest “Yes” votes would rank higher on the scale measuring helpfulness. A pending suggestion may also be compared to other pending suggestions to determine whether a particular contact is the best contact to suggest a particular piece of information or activity. A pending suggestion coming from a highly ranked contact may, therefore, become more valuable than a similar pending suggestion coming from a contact who has low rank, based on the quantity or quality of electronic help suggestions originating from that contact

At block 208, an additional determination may be made regarding a likelihood of approval of the pending electronic help suggestion from the at least one contact. In this regard, it may be analyzed whether or not the pending suggestion would be approved by the at least one contact, when provided. It may be implemented in such a way that, in presence of potentially personal or sensitive information, for example, financial, medical or other sensitive information, it may be determined that an electronic help suggestion based on or including such information should not be provided to the one or more contacts. A likelihood of approval may also depend on whether or not the at least one contact and the user requesting help have recently interacted at the social networking site, whether or not they have taken any actions toward each other that may suggest that a suggestion is not likely to be approved. For example, if a contact removes a user from his circles or list of friends or visa versa, un-subscribes from the other's feed or otherwise displays an action suggesting that a help suggestion may not be approved, such action may cause an otherwise appropriate electronic suggestion to not be provided to the contact. A multitude of aspects may, therefore, be determined and weighted when determining whether an electronic help suggestion should be provided to one or more contacts based on the one or more contacts' online activity.

Once it is determined that an electronic help suggestion should be provided to the at least one contact based on the at least one contact's online activity, a help suggestion type is determined at block 209. The type of electronic help suggestion is determined based on the type of online activity the at least one contact is engaged in. Thus, if a particular contact is browsing a website, a “share web-page” type of suggestion may be selected. If a particular contact is viewing a photo, a “share photo” type of suggestion may be selected. When a particular contact has checked in at an establishment, a “start hangout” type of suggestion or its equivalent may be selected. Likewise, when a certain contact is viewing an email that is relevant to the electronic help request, and the contact has elected to include his email in the online activities permitted to be used for responding to a particular electronic help request, a “forward email” type of suggestion may be selected.

At block 210, an electronic help suggestion is generated at least in part based on the at least one contact's online activity and provided to the at least one contact. For example, if “User1@email.com” is shopping for electronics, he may submit a help request regarding “Electronics” to Contact 1, Contact 2 . . . Contact “n.” If it is determined that Contact 1 is engaged in relevant online activity, such as, for example conducting an online search for the term “Home Electronics” to learn more about the various models, when Contact 1 clicks through the top search results, it is noted that he is engaged in online activity that is relevant to “User1@email.com's” help request on “Electronics,” and, therefore, the page Contact 1 is viewing may be relevant to “User1@email.com.” Right then, in the search result display, or alternatively, when Contact 1 enters a relevant website, a help suggestion is provided to Contact 1 informing him that the page he is viewing is highly relevant to “User1@email.com's” help request and suggesting that he share this webpage with “User1@email.com.” The help suggestion may be a simple, non-intrusive message displayed on the screen or a more prominent alert displayed as a banner or another similar mechanism. Contact 1 may then approve the electronic help suggestion or decline it. According to an aspect of the disclosed technology, Contact 1 may share the webpage at the social networking site. Alternatively, the website may be shared via an electronic message, an SMS, or otherwise.

Similarly, “User2@email.com” may request help regarding “Car Shopping” from Contact 1, Contact 2 . . . Contact “n.” When Contact 2 receives a promotional email for a deal on a car from a local dealership, it will be determined that the email may be relevant to “User2@email.com's” electronic help request and a message suggesting that Contact 2 forward the email to “User2@email.com” will be displayed. Contact 2 may then approve the electronic help suggestion or decline it. As stated previously, Contact 2 has to have explicitly approved his email to be used for this particular electronic help request when accepting the electronic help invitation. According to a further aspect of the subject technology, embodiments permitting an acceptance to be inferred from a contact's positive interaction with an electronic help suggestion do not automatically utilize a contact's email. Accordingly, email may only be used in handling help requests for which an explicit acceptance allowing email usage has been received from a contact. Likewise, when Contact 3 is physically at a car dealership, his phone may detect that he is at a car dealership, either through Contact 3 checking in online, at a social networking site, or otherwise, and a suggestion may be provided to Contact 3 to start a chat or another type of electronic or virtual meeting with “User2@email.com” and do a visual tour of the different cars at the dealership.

According to an aspect of the disclosed subject matter, an electronic invitation acceptance may be inferred from a contact's positive interaction with an electronic help suggestion. Positive interaction with an electronic help suggestion may include a contact approving it simply by way of permitting the suggestion to be transmitted to the user who invited the contact to help him. As such, acceptance of an electronic help invitation may be inferred from a contact's approval of a first provided electronic help suggestion. Conversely, if a contact declines a first provided electronic help suggestion, and the contact did not explicitly accept the electronic help invitation on behalf of the user, it may be inferred that the contact does not wish to participate. Where no explicit acceptance is received from a contact, only the contact's public online activity is used for the purpose of making the first help suggestion.

### IV. Example User Interfaces for Providing an Electronic Help Suggestion

FIGS. 3A and 3B is a series of diagrams of an example user interface for providing an electronic help suggestion in a social networking site, according to an aspect of the disclosed technology. FIG. 3A illustrates an example user interface for a user creating an electronic help request at a social networking site. FIG. 3 A depicts a “User Id.” field 310, “Help Categories” field 312, “Select Contacts” field 314 and a “Send Help Request” button 316. The “Help Categories” field 312 may include a list of pre-defined topics, as illustrated in FIG. 3A, from which the user may select one or several categories of interest. Alternatively, or in addition thereto, a field may be provided for a user to enter free-from content. The content entered by the user may include free-form text, images, links, audio or video files, or other similar content, which may be classified into help categories. The “Select Contacts” field 314 may include a drop down menu for the user to select as many contacts as the user wishes to invite. A help request may be sent with selecting the “Send Help Request” button 316.

FIG. 3B illustrates an example user interface for a contact responding to an electronic help invitation received at a social networking site, according to an aspect of the disclosed technology. Field 320 may display the one or more categories on which a user may be seeking the contact's help. A contact may select any one of actions 322 to “Accept Help Invitation,” “Decline Help Invitation,” or “Remind Me Later” which allows a particular contact to snooze the help invitation. The particular contact may thus select any one option. When the particular contact accepts the electronic help invitation, he authorizes the system to monitor certain online activities for providing electronic help suggestions. When the contact declines the help invitation, he, correspondingly, will not be provided with electronic help suggestions. In an alternative implementation, the contact may be provided with at least one such help suggestion, to confirm whether or not he is willing to participate, or to correct an inadvertent decline. When a contact selects to be reminded later, he may automatically receive a periodic reminder to accept his invitation. He may also be provided with help suggestions while his invitation is snoozed.

As part of accepting a help invitation, a particular contact may select which of his online activities may be used to help the user. For example, a contact may decline to provide suggestions based on his email or browsing history, as depicted at 324.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic, flash, optical or other storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

### IV. Example Systems for Providing Electronic Help Suggestions

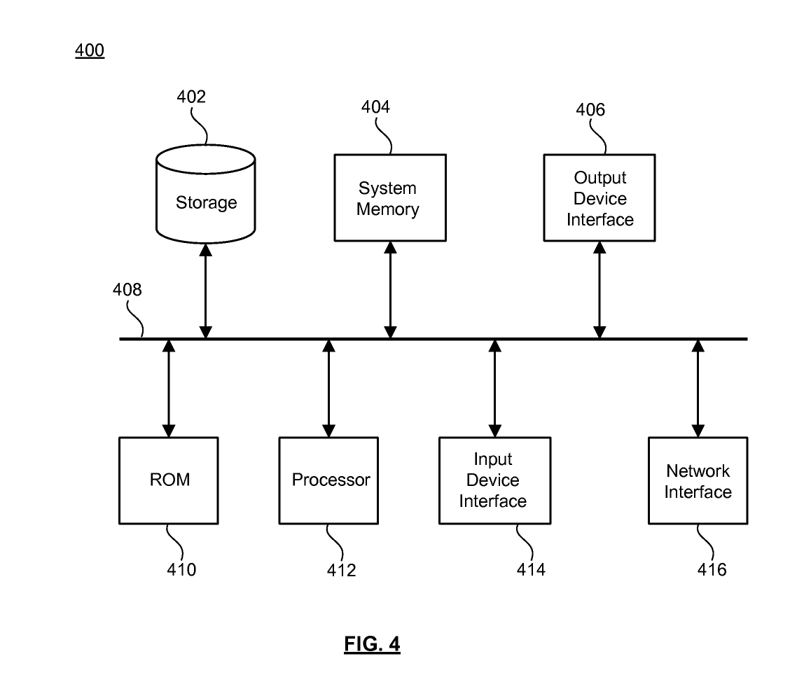

FIG. 4 conceptually illustrates an example of an electronic system within which some examples of the subject technology may be implemented. Electronic system 400 can be a computer, phone, PDA, or any other sort of electronic device. Such an electronic system includes various types of computer readable media and interfaces for various other types of computer readable media. Electronic system 400 includes a bus 408, processing unit(s) 412, a system memory 404, a read-only memory (ROM) 410, a permanent storage device 402, an input device interface 414, an output device interface 406, and a network interface 416.

Bus 408 collectively represents all system, peripheral, and chipset buses that communicatively connect the numerous internal devices of electronic system 400. For instance, bus 408 communicatively connects processing unit(s) 412 with ROM 410, system memory 404, and permanent storage device 402.

From these various memory units, processing unit(s) 412 retrieves instructions to execute and data to process in order to execute the processes of the subject disclosure. The processing unit(s) can be a single processor or a multi-core processor in different implementations.

ROM 410 stores static data and instructions that are needed by processing unit(s) 412 and other modules of the electronic system. Permanent storage device 402, on the other hand, is a read-and-write memory device. This device is a non-volatile memory unit that stores instructions and data even when electronic system 400 is off. Some implementations of the subject disclosure use a mass-storage device (such as a magnetic or optical disk and its corresponding disk drive) as permanent storage device 402.

Other implementations use a removable storage device (such as a floppy disk, flash drive, and its corresponding disk drive) as permanent storage device 402. Like permanent storage device 402, system memory 404 is a read-and-write memory device. However, unlike storage device 402, system memory 404 is a volatile read-and-write memory, such a random access memory. System memory 404 stores some of the instructions and data that the processor needs at runtime. In some implementations, the processes of the subject disclosure are stored in system memory 404, permanent storage device 402, and/or ROM 410. For example, the various memory units include instructions for providing electronic help suggestions at a social networking site in accordance with some implementations. From these various memory units, processing unit(s) 412 retrieves instructions to execute and data to process in order to execute the processes of some implementations.

Bus 408 also connects to input and output device interfaces 414 and 406. Input device interface 414 enables the user to communicate information and select commands to the electronic system. Input devices used with input device interface 414 include, for example, alphanumeric keyboards and pointing devices (also called “cursor control devices”). Output device interfaces 406 enables, for example, the display of images generated by the electronic system 400. Output devices used with output device interface 406 include, for example, printers and display devices, such as cathode ray tubes (CRT) or liquid crystal displays (LCD). Some implementations include devices such as a touch screen that functions as both input and output devices.

Finally, as shown in FIG. 4, bus 408 also couples electronic system 400 to a network (not shown) through a network interface 416. In this manner, the computer can be a part of a network of computers (such as a local area network (“LAN”), a wide area network (“WAN”), or an Intranet, or a network of networks, such as the Internet. Any or all components of electronic system 400 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of exemplary approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims.

1. A computer-implemented method for providing an electronic help suggestion, the method comprising:
receiving, using one or more computing devices, from a user, an electronic help request identifying one or more contacts;
classifying, using the one or more computing devices, the received electronic help request into one or more help categories;
generating, using the one or more computing devices, an electronic help invitation at least in part based on the received electronic help request and the one or more help categories;
sending, using the one or more computing devices, the electronic help invitation to the one or more contacts identified in the electronic help request;
receiving, using the one or more computing devices, an acceptance of the electronic help invitation from at least one contact of the one or more contacts identified in the electronic help request; and
providing an electronic help suggestion, using the one or more computing devices, to the at least one contact of the one or more contacts who accepted the electronic help invitation based on the at least one contact's of one or more contacts online activity,
wherein providing the electronic help suggestion comprises providing a user interface to the at least one contact, and
wherein the user interface provides for the at least one contact to select, for each of plural types of online activities corresponding to an online history of the at least one contact, whether online activity of that type, corresponding to the online history of the at least one contact, is permitted or denied for use in addressing the electronic help request.

2. The computer-implemented method of claim 1, wherein providing the electronic help suggestion to the at least one contact of the one or more contacts who accepted the electronic help invitation based on the at least one contact's of the one or more contacts online activity further comprises:
determining that the one or more contacts is engaged in online activity relevant to the electronic help request prior to providing the electronic help suggestion.

3. The computer-implemented method of claim 2, wherein determining whether the one or more contacts is engaged in online activity relevant to the electronic help request comprises comparing the one or more classified help categories to the one or more contacts' online activity.

4. The computer-implemented method of claim 3, wherein comparing the one or more classified help categories to the one or more contacts' online activity comprises comparing the one or more classified help categories to a preferred online activity selected by the one or more contacts who accepted the electronic help invitation.

5. The computer-implemented method of claim 1, wherein providing the electronic help suggestion to the at least one contact of the one or more contacts who accepted the electronic help invitation based on the at least one contact's of the one or more contacts online activity further comprises:
determining that an electronic help suggestion quota has not been reached for the electronic help request prior to providing the electronic help suggestion.

6. The computer-implemented method of claim 1, wherein providing the electronic help suggestion to the at least one contact of the one or more contacts who accepted the electronic help invitation based on the at least one contact's of the one or more contacts online activity further comprises:
determining that the at least one contact of the one or more contacts who accepted the electronic help invitation is likely to approve the electronic help suggestion prior to providing the electronic help suggestion.

7. The computer-implemented method of claim 1, wherein providing the electronic help suggestion to the at least one contact of the one or more contacts who accepted the electronic help invitation based on the at least one contact's of the one or more contacts online activity further comprises:
determining that the electronic help suggestion is expected to be valuable to the user from whom the electronic help request identifying the one or more contacts is received prior to providing the electronic help suggestion.

8. The computer-implemented method of claim 1, wherein providing the electronic help suggestion to the at least one contact of the one or more contacts who accepted the electronic help invitation based on the at least one contact's of the one or more contacts online activity includes selecting an electronic help suggestion type to provide to the at least one contact of the one or more contacts based on a type of the at least one contact's of the one or more contacts online activity.

9. The computer-implemented method of claim 1, further comprising:
generating the electronic help suggestion at least in part based on the one or more contacts' online activity.

10. A non-transient machine-readable medium comprising instructions stored therein, which when executed by a machine, cause the machine to perform operations comprising:
receiving from a user an electronic help request identifying one or more contacts;
classifying the received electronic help request into one or more help categories;
sending an electronic help invitation to the one or more contacts identified in the electronic help request;
receiving an acceptance of the electronic help invitation from at least one contact of the one or more contacts identified in the electronic help request;
determining whether the one or more contacts is engaged in online activity relevant to the electronic help request, wherein determining whether the one or more contacts is engaged in online activity relevant to the electronic help request includes comparing the one or more classified help categories to the one or more contacts' online activity;
determining an electronic help suggestion type to provide to the one or more contacts based on a type of the one or more contacts' online activity; and
providing an electronic help suggestion to the at least one contact of the one or more contacts who accepted the electronic help invitation based on the one or more contacts' online activity, according to the determined electronic help suggestion type,
wherein providing the electronic help suggestion comprises providing a user interface to the at least one contact, and
wherein the user interface provides for the at least one contact to select, for each of plural types of online activities corresponding to an online history of the at least one contact, whether online activity of that type, corresponding to the online history of the at least one contact, is permitted or denied for use in addressing the electronic help request.

11. The non-transient machine-readable medium of claim 10, wherein comparing the one or more classified help categories to the one or more contacts' online activity comprises comparing the one or more classified help categories to a preferred online activity selected by the one or more contacts who accepted the electronic help invitation.

12. The non-transient machine-readable medium of claim 10, wherein providing the electronic help suggestion to at least one contact of the one or more contacts who accepted the electronic help invitation based on the at least one contact's of the one or more contacts online activity further comprises:
determining that an electronic help suggestion quota has not been reached for the electronic help request prior to providing the electronic help suggestion.

13. The non-transient machine-readable medium of claim 10, wherein providing the electronic help suggestion to the at least one contact of the one or more contacts who accepted the electronic help invitation based on the at least one contact's of one or more contacts online activity further comprises:
determining that the one or more contacts who accepted the electronic help invitation is likely to approve the electronic help suggestion prior to providing the electronic help suggestion.

14. The non-transient machine-readable medium of claim 10, wherein providing the electronic help suggestion to the at least one contact of the one or more contacts who accepted the electronic help invitation based on the at least one contact's of the one or more contacts online activity further comprises:
determining that the electronic help suggestion is expected to be valuable to the user from whom the electronic help request identifying the one or more contacts is received prior to providing the electronic help suggestion.

15. The non-transient machine-readable medium of claim 10, the operations further comprising:
generating the electronic help suggestion at least in part based on the one or more contacts' online activity.

16. A system for processing electronic messages, the system comprising:
one or more processors; and
a machine-readable medium comprising instructions stored therein, which when executed by the processors, cause the processors to perform operations comprising:
receiving from a user an electronic help request identifying one or more contacts;
classifying the received electronic help request into one or more help categories;
sending an electronic help invitation to the one or more contacts identified in the electronic help request, to provide help to the user on the one or more help categories classified in the electronic help request;
determining that at least one contact's of the one or more contacts online activity is relevant to the electronic help invitation; and
providing an electronic help suggestion based on the at least one contact's of one or more contacts online activity that is relevant to the electronic help invitation, to the at least one contact of the one or more contacts who received the electronic help invitation,
wherein providing the electronic help suggestion comprises providing a user interface to the at least one contact, and
wherein the user interface provides for the at least one contact to select, for each of plural types of online activities corresponding to an online history of the at least one contact, whether online activity of that type, corresponding to the online history of the at least one contact, is permitted or denied for use in addressing the electronic help request.

17. The system of claim 16, the operations further comprising:
receiving an acceptance of the electronic help invitation from the one or more contacts to provide help to the user on the one or more help categories classified in the electronic help request.

18. The system of claim 17, wherein receiving an acceptance of the electronic help invitation from the one or more contacts to provide help to the user on the one or more help categories classified in the electronic help request further comprises:
receiving an indication of positive interaction with the electronic help suggestion by the one or more contacts; and
inferring an acceptance of the electronic help invitation from the received indication of positive interaction with the electronic help suggestion by the one or more contacts.

19. The system of claim 16, wherein determining that the one or more contacts' online activity is relevant to the electronic help invitation includes comparing the one or more classified help categories to the one or more contacts' online activity.

20. The system of claim 19, wherein comparing the one or more classified help categories to the one or more contacts' online activity comprises comparing the one or more classified help categories to a preferred online activity selected by the one or more contacts who accepted the electronic help invitation.

21. The system of claim 16, wherein providing an electronic help suggestion based on the one or more contacts' online activity that is relevant to the electronic help invitation, to the one or more contacts who received the electronic help invitation further comprises;
determining that an electronic help suggestion quota has not been reached for the electronic help request prior to providing the electronic help suggestion.

22. The system of claim 16, wherein providing an electronic help suggestion based on the one or more contacts' online activity that is relevant to the electronic help invitation, to the one or more contacts who received the electronic help invitation further comprises:
determining that the one or more contacts who accepted the electronic help invitation is likely to approve the electronic help suggestion prior to providing the electronic help suggestion.

23. The system of claim 16, wherein providing an electronic help suggestion based on the one or more contacts' online activity that is relevant to the electronic help invitation, to the one or more contacts who received the electronic help invitation further comprises:
determining that the electronic help suggestion is expected to be valuable to the user from whom the electronic help request identifying the one or more contacts is received prior to providing the electronic help suggestion.

24. The system of claim 16, providing an electronic help suggestion based on the one or more contacts' online activity that is relevant to the electronic help invitation, to the one or more contacts who received the electronic help invitation includes selecting an electronic help suggestion type to provide to the one or more contacts based on a type of the one or more contacts' online activity.

25. The system of claim 16, the operations further comprising:
generating the electronic help suggestion at least in part based on the one or more contacts' online activity.
